(19) United States
(12) Patent Application Publication
(10) Pub. No.: US 2022/0228636 A1
(43) Pub. Date: Jul. 21, 2022

(54) ENVIRONMENT-FRIENDLY FRICTION MATERIAL AND PRODUCT THEREOF

(71) Applicant: Jinjiang Kaiyan New Material Technology Co., Ltd., Quanzhou City (CN)

(72) Inventor: Hua'nan Wang, Quanzhou City (CN)

(21) Appl. No.: 17/153,903

(22) Filed: Jan. 21, 2021

(51) Int. Cl. F16D 69/02

(52) U.S. Cl. CPC F16D 69/028; F16D 2200/0065; F16D 2200/003; F16D 2250/0007; F16D 2200/0039

(57) ABSTRACT

The invention relates to an environment-friendly friction material, which consists of the following components in parts by weight: 8-15 parts of a binding material, 3-8 parts of an organic fiber, 3-8 parts of an inorganic fiber, 3-8 parts of an anti-friction material, 15-25 parts of granite powder, 35-40 parts of marble powder, 6-10 parts of a modified organic filling material, 5-10 parts of an acidity or alkalinity regulating material, and 0.5-4.5 parts of a non-copper metal material, wherein the modified organic filling material consists of the following components in parts by weight: 25-50 parts of tyre powder, 15-25 parts of a shoe sole waste, 10-15 parts of a sepiolite fiber, 2-3 parts of a silane coupling agent, 2-5 parts of a cashew nut shell liquid, and 0.5-2 parts of an activator, with the shoe sole waste including 15-30% of POE and 5-15% of EPDM. The invention is reasonable in compatibility, and has excellent properties such as reduced noise, heat resistance and little damage to mating plates while ensuring a moderate and stable friction coefficient, thereby changing waste materials into objects of value and achieving energy conservation and environmental protection effects.

### BACKGROUND OF THE INVENTION

### 1. Technical Field

The invention belongs to the field of friction material technologies, and in particular, to an environment-friendly friction material and a product thereof.

### 2. Description of Related Art

Brake pads are the most crucial safety parts in automobile brake systems, and play a decisive role in achieving all the braking effects. In general, a brake pad is composed of a steel plate, a bonded heat insulation layer and a friction block, wherein the heat insulation layer is composed of materials that do not transfer heat, in order to insulate the heat. The friction block is composed of a friction material and a binding agent, and during braking, is squeezed onto a brake disc or brake drum to cause friction, thereby achieving the purpose of slowing down and braking a car.

A brake friction material should mainly meet the following technical requirements: (1) an appropriate and stable friction coefficient, with a small difference between dynamic and static friction coefficients; (2) good mechanical strength and physical properties; (3) good heat resistance and wear resistance; and (4) low friction noise, little damage to mating plates, environment friendliness, no pollution and the like.

In addition, a process for processing stones involves a large amount of waste materials, which mainly include leftover materials and stone powder. Moreover, a large amount of stone powder with a small particle size is mainly produced during the cutting of the stones. Such stone powder is collected and undergoes solid-liquid separation to form solids that are stone powder lumps containing a certain amount of moisture. There is no good way to deal with such stone powder, which can only be piled up. However, if the stone powder is only piled up, a waste of land and resources will be caused, and water sources may be polluted, leading to serious hazards. Therefore, how to deal with and make use of such stone powder including marble powder and granite powder, and how to change waste into things of value have become a matter of urgent concern for stone enterprises.

Moreover, a large amount of show sole waste will be produced during the production and processing in shoe sole factories. The shoe sole waste is also recyclable. If the shoe sole waste is not recycled but burned directly, serious atmospheric pollution will be caused, and if recycled, both environment protection and production cost reduction can be realized.

A Chinese Patent Publication (CN109654144A) discloses a friction material for an automobile friction plate, which includes the following components in a formula in percentage by mass: 10-12% of barite powder, 10-16% of steel fiber, 8-14% of reduced iron powder, 10-15% of resin, 1-3% tyre powder, 1-3% of nitrile rubber powder, 2-5% of friction powder, 1-5% of carbon black, 1-2% of alumina, 1-7% of vermiculite, 1-5% of chrome ore powder, 1-5% of brass powder, 1-10% of paper fiber and 5-15% of mineral fiber. This solution provides a technical thought of using the tyre powder as a component of the friction material. However, there is still no precedent research in the prior art in which tyre powder, stone waste, and the shoe sole waste is added to the friction material.

### BRIEF SUMMARY OF THE INVENTION

An object of the invention is to provide an environment-friendly friction material prepared from tyre powder, granite powder, marble powder and other functional components, which reduces environmental pollution while ensuring that the friction property of the friction material meets the requirements.

To achieve the object above, the invention employs the following technical solutions.

Environment-friendly friction material consists of the following components in parts by weight: 8-15 parts of a binding material, 3-8 parts of an organic fiber, 3-8 parts of an inorganic fiber, 3-8 parts of an anti-friction material, 15-25 parts of granite powder, 35-40 parts of marble powder, 6-10 parts of a modified organic filling material, 5-10 parts of an acidity or alkalinity regulating material, and 0.5-4.5 parts of a non-copper metal material.

Among them, the binding material is one or a combination of some of phenolic resin, boron modified phenolic resin, cashew nut shell liquid modified phenolic resin and natural rubber; the organic fiber is one or a combination of some of an aramid fiber and a polyacrylic fiber; the inorganic fiber is one or a combination of some of a potassium titanate fiber, a glass fiber, a ceramic fiber, and a basalt fiber; the anti-friction material is one or a combination of some of graphite, tin sulfide, and molybdenum disulfide; the acidity or alkalinity regulating material is one or a combination of some of calcium hydroxide, gypsum powder, lime, and slaked lime; and the non-copper metal material is one or a combination of some of titanium, iron, nickel, zinc, and heat-resistant duralumin.

The modified organic filling material consists of the following components in parts by weight: 20-50 parts of tyre powder, 15-25 parts of a shoe sole waste, 10-15 parts of a sepiolite fiber, 2-3 parts of a silane coupling agent, 2-5 parts of a cashew nut shell liquid, and 0.5-2 parts of an activator, with the shoe sole waste including 15-30% of POE and 5-15% of EPDM.

A process for preparing the modified organic filling material includes the following steps:

S1, modification of the sepiolite fiber: adding 10-15 parts of the dried sepiolite fiber and deionized water at a solid-to-liquid ratio of 1:5 to a dispersant, dispersing at 1500 r/min-1800 r/min for 5 min, then adding 2-3 parts of the silane coupling agent, dispersing at an increased revolving speed of 2500 r/min for 60 min to obtain a slurry, which is then dried in a constant-temperature drying oven at 110° C., and then finely grinding the dried modified sepiolite fiber by a ball mill for later use;

S2, activation of the tyre powder: mixing the 25-50 parts of tyre powder, the 2-5 parts of a cashew nut shell liquid, and the 0.5-2 parts of an activator in a high-speed mixer at a revolving speed of 70 r/min-100 r/min for 5 min-10 min to obtain premixed powder, which is then activated and modified in a torque rheometer with a revolving speed of 70 r/min-100 r/min and a temperature of 120° C-160° C. for 5 min-30 min to obtain modified tyre powder, and finally, cooling the modified tyre powder under natural conditions to normal temperature for later use;

S3, preprocessing of the shoe sole waste: stripping to remove miscellaneous substances and keep EVA insoles, physically shredding the EVA insoles in a shredding machine, and washing and drying the shredded EVA insoles to obtain the shoe sole waste for later use; and

S4, mixing the modified sepiolite fiber from Step S1, the modified tyre powder from Step S2 and the shoe sole waste from Step S3 fully and evenly, feeding to a double-screw extruder for melting, extruding and granulating.

The invention further provides an environment-friendly friction material product, which includes a friction layer prepared from the environment-friendly friction material.

Compared with the prior art, the invention has the following beneficial effects.

According to the invention, the granite powder and the marble powder together with the modified organic filling material mainly made of the tyre powder and shoe sole powder are added to the formula of the friction material in combination with compatible components such as the binding material, the organic fiber material, the inorganic fiber material, and the non-copper metal material. The invention is reasonable in compatibility, and has the excellent properties such as reduced noise, heat resistance and little damage to mating plates while ensuring a moderate and stable friction coefficient, thereby changing waste materials into things of value and achieving energy conservation and environmental protection effects.

According to the invention, the tyre powder is activated and modified with the cashew nut shell liquid and the activator, and added with active groups on the surface. From one aspect, this can improve the binding tightness of the tyre powder with the shoe sole waste and synergistically toughen the tyre powder together with the POE in the shoe sole waste; and from another aspect, this can break cross-linked networks on the surface of the tyre powder to form rubber particles having small molecular segments of a certain viscosity and with elasticity inside. As a result, internal and external structures are combined to form a structure similar to a “core-shell structure”, which makes the modified tyre powder better in overall performance and heat resistance. The modified tyre powder and sepiolite fiber have many holes on the surface and have large specific surface area, which promotes a binding force among the modified tyre powder, the shoe sole waste and the sepiolite fiber, can reduce vibrations and absorb noises of a certain wavelength, and meanwhile, can better fit mating surfaces to prevent damages to the mating surfaces and reduces damages caused by the braking to the mating plates at the same time.

### BRIEF DESCRIPTION OF THE SEVERAL VIEWS OF THE DRAWINGS

[symbol]

### DETAILED DESCRIPTION OF THE INVENTION

The following Examples 1-8 and Comparative Examples 1-4 are proposed for the environment-friendly friction material according to the invention. Among them, Comparative Example 1 is a control experiment of Example 1, with a difference in that the chemical component POE has a content of 12% the shoe sole waste used in Comparative Example 1; Comparative Example 2 is also the control experiment of Example 1, with a difference in that a mixture of the tyre powder and the shoe sole waste at the same mass ratio are only used in the modified organic filling material in Comparative Example 2, without an modification; Comparative Example 3 is also the control experiment of Example 1, with a difference in that the parts by weight of the modified organic filling material in Comparative Example 3 is 5 and the process for preparing the modified organic filling material is the same as that in Example 1; and Comparative Example 4 is also the control experiment of Example 1, with a difference in that the modified organic filling material, the granite powder and the marble powder are not used and substituted with zirconium silicate, alumina, calcium carbonate, mica, polytetrafluoroethylene, friction powder of cashew nut shell liquid. References may be made to Tables 1, 2, 3 and 4 for the component composition in Examples 1-8 and Comparative Examples 1-4.

TABLE 1
Specific composition of the modified organic filling materials according to Examples
1-8 and Comparative Examples 1-3 of the invention Modified organic filler material

| | Tyre | shoe sole | Sepiolite | Silane coupling | Cashew nut | Activator |
|---|---|---|---|---|---|---|
| | powder | waste | fiber | agent Si-998 | shell liquid | 450 |
| Example 1 | 20 | 20 | 10 | 2 | 2 | 0.5 |
| Example 2 | 25 | 20 | 12 | 3 | 4.5 | 1 |
| Example 3 | 22 | 15 | 10 | 2.5 | 3 | 1 |
| Example 4 | 25 | 25 | 15 | 3 | 5 | 2 |
| Example 5 | 22 | 18 | 12 | 2.5 | 3 | 1 |
| Example 6 | 20 | 25 | 15 | 3 | 3 | 0.5 |
| Example 7 | 25 | 18 | 10 | 2 | 3 | 2 |
| Example 8 | 20 | 15 | 12 | 2 | 3 | 0.8 |
| Comparative | 20 | 20 | 10 | 2 | 2 | 0.5 |
| Example 1 | | | | | | |
| Comparative | 20 | 20 | — | — | — | — |
| Example 2 | | | | | | |
| Comparative | 20 | 20 | 10 | 2 | 2 | 0.5 |
| Example 3 | | | | | | |

TABLE 2
Specific composition of the environment-friendly friction
materials according to Examples 1-4 of the invention

| Material | Specific components | Example | Example | Example | Example |
|---|---|---|---|---|---|
| composition | (parts) | 1 | 2 | 3 | 4 |
| Binding material | Phenolic Resin | 12 | 10 | 10 | — |
| (8-15 parts) | Boron modified | — | — | 2 | — |
| | phenolic resin | | | | |
| | Cashew nut shell liquid | — | 5 | — | 6 |
| | modified phenolic | | | | |
| | resin | | | | |
| | Natural rubber | — | — | 3 | 2 |
| Organic fiber | Aramid fiber | 3 | 3 | 2 | — |
| material (3-8 | Polyacrylic fiber | 2 | — | 3 | 5 |
| parts) | | | | | |
| Inorganic fiber | Potassium titanate fiber | — | 2 | 2 | — |
| material | Glass fiber | — | — | 2 | — |
| (3-8 parts) | Ceramic fiber | 4 | 2 | — | 3 |
| | Basalt fiber | 4 | 2 | 3 | 3 |
| Anti-friction | Graphite | 2 | 3 | 2 | — |
| material (3-8 | Tin sulfide | — | — | 2 | 2 |
| parts) | Molybdenum disulfide | 3 | — | — | 6 |
| Granite powder (15-25 parts) | | 20 | 25 | 15 | 20 |
| Marble powder (35-40 parts) | | 35 | 40 | 35 | 40 |
| Modified organic filler material (6-10 parts) | | 8 | 10 | 6 | 8 |
| Acidity or | Calcium hydroxide | 5 | 3 | 2 | — |
| alkalinity | Gypsum powder | — | — | 3 | — |
| regulating | Lime | — | 5 | — | 2 |
| material (5-10 | Slaked lime | — | — | — | 3 |
| parts) | | | | | |
| Non-copper metal | Titanium | — | 1 | 1.5 | — |
| material (0.5-4.5 | Iron | 0.5 | — | — | — |
| parts) | Nickel | 0.5 | 1 | — | 0.5 |
| | Zinc | — | 0.5 | 0.5 | 1 |
| | Heat-resistant | 1 | 1 | 0.5 | 1 |
| | duralumin | | | | |

TABLE 3
Specific composition of the environment-friendly friction
materials according to Examples 5-8 of the invention

| Material | Specific components | Example | Example | Example | Example |
|---|---|---|---|---|---|
| composition | (parts) | 5 | 6 | 7 | 8 |
| Binding material | Phenolic Resin | 10 | — | 8 | — |
| (8-15 parts) | Boron modified | — | — | 5 | 8 |
| | phenolic resin | | | | |
| | Cashew nut shell liquid | 2 | 8 | — | — |
| | modified phenolic | | | | |
| | resin | | | | |
| | Natural rubber | 3 | — | — | 2 |
| Organic fiber | Aramid fiber | 5 | 3 | 3 | 3 |
| material (3-8 | Polyacrylic fiber | — | 3 | 5 | — |
| parts) | | | | | |
| Inorganic fiber | Potassium titanate fiber | 1 | — | 1.5 | 1 |
| material | Glass fiber | — | 1 | — | 0.5 |
| (3-8 parts) | Ceramic fiber | 1 | — | 0.5 | — |
| | Basalt fiber | 1.5 | 3.5 | 1 | 2 |
| Anti-friction | Graphite | — | 1 | 1 | 2 |
| material (3-8 | Tin sulfide | 1.5 | — | 0.5 | — |
| parts) | Molybdenum disulfide | 2.5 | 3 | 5 | 3 |
| Granite powder (15-25 parts) | | 25 | 25 | 15 | 20 |
| Marble powder (35-40 parts) | | 35 | 40 | 35 | 40 |
| Modified organic filler material (6-10 parts) | | 10 | 10 | 8 | 8 |
| Acidity or | Calcium hydroxide | 5 | 5 | 2 | 5 |
| alkalinity | Gypsum powder | — | — | — | — |
| regulating | Lime | — | — | — | — |
| material (5-10 | Slaked lime | — | — | 3 | — |
| parts) | | | | | |
| Non-copper metal | Titanium | 0.5 | 1 | — | — |
| material (0.5-4.5 | Iron | — | 0.5 | — | — |
| parts) | Nickel | 1.5 | 1 | 2 | 1 |
| | Zinc | — | 0.5 | — | — |
| | Heat-resistant | 1 | — | 2 | 1.5 |
| | duralumin | | | | |

TABLE 4
Specific composition of the environment-friendly friction materials
according to Comparative Examples 1-4 of the invention

| | Specific | | | | |
|---|---|---|---|---|---|
| Material | components | Comparative | Comparative | Comparative | Comparative |
| composition | (parts) | Example 1 | Example 2 | Example 3 | Example 4 |
| Binding material | Phenolic Resin | 12 | 12 | 12 | 12 |
| | Boron modified | — | — | — | — |
| | phenolic resin | | | | |
| | Cashew nut | — | — | — | — |
| | shell liquid | | | | |
| | modified | | | | |
| | phenolic resin | | | | |
| | Natural rubber | — | — | — | — |
| Organic | Aramid fiber | 3 | 3 | 3 | 3 |
| fiber | Polyacrylic fiber | 2 | 2 | 2 | 2 |
| material | | | | | |
| Inorganic | Potassium titanate | — | — | — | — |
| fiber | fiber | | | | |
| material | Glass fiber | — | — | — | — |
| | Ceramic fiber | 4 | 4 | 4 | 4 |
| | Basalt fiber | 4 | 4 | 4 | 4 |
| Anti-friction | Graphite | 2 | 2 | 2 | 2 |
| material | Tin sulfide | — | — | — | — |
| | Molybdenum | 3 | 3 | 3 | 3 |
| | disulfide | | | | |
| Granite powder | | 20 | 20 | 20 | — |
| Marble powder | | 35 | 35 | 35 | — |
| Zirconium Silicate | | — | — | — | 20 |
| Alumina | | — | — | — | 15 |
| Calcium carbonate | | — | — | — | 25 |
| Mica | | — | — | — | 5 |
| Polytetrafluoroethylene | | — | — | — | 5 |
| Friction powder of cashew | | — | — | — | 8 |
| nut shell liquid | | | | | |
| Modified organic filler | | 8 | 8 | 5 | — |
| material (6-10 parts) | | | | | |
| Acidity or | Calcium hydroxide | 5 | 5 | 5 | 5 |
| alkalinity | Gypsum powder | — | — | — | — |
| regulating | Lime | — | — | — | — |
| material | Slaked lime | — | — | — | — |
| Non-copper | Titanium | — | — | — | — |
| metal | Iron | 0.5 | 0.5 | 0.5 | 0.5 |
| material | Nickel | 0.5 | 0.5 | 0.5 | 0.5 |
| | Zinc | — | — | — | — |
| | Heat-resistant | 1 | 1 | 1 | 1 |
| | duralumin | | | | |

A process for preparing the modified organic filling material according to each of the above Examples 1-8 and Comparative Examples 1 and 3 includes the following steps:

S1, modification of the sepiolite fiber: adding 10-15 parts of the dried sepiolite fiber and deionized water at a solid-to-liquid ratio of 1:5 to a dispersant, dispersing at 1500 r/min-1800 r/min for 5 min, then adding 2-3 parts of the silane coupling agent, dispersing at an increased revolving speed of 2500 r/min for 60 min to obtain a slurry, which is then dried in a constant-temperature drying oven at 110° C., and then finely grinding the dried modified sepiolite fiber by a ball mill for later use;

S2, activation of the tyre powder: mixing the 20-50 parts of tyre powder, the 2-5 parts of a cashew nut shell liquid, and the 0.5-2 parts of an activator in a high-speed mixer at a revolving speed of 70 r/min-100 r/min for 5 min-10 min to obtain premixed powder, which is then activated and modified in a torque rheometer with a revolving speed of 70 r/min-100 r/min and a temperature of 120° C-160° C. for 5 min-30 min to obtain modified tyre powder, and finally, cooling the modified tyre powder under natural conditions to normal temperature for later use;

S3, preprocessing of the shoe sole waste: stripping to remove miscellaneous substances and keep EVA insoles, physically shredding the EVA insoles in a shredding machine, and washing and drying the shredded EVA insoles to obtain the shoe sole waste for later use; and

S4, mixing the modified sepiolite fiber from Step S1, the modified tyre powder from Step S2 and the shoe sole waste from Step S3 fully and evenly, feeding to a double-screw extruder for melting, extruding and granulating.

In addition, the invention further provides an environment-friendly friction material product, which includes a friction layer prepared from the environment-friendly friction material according to each of the above Examples 1-8.

According to the respective formulas shown in Tables 1-4, the respective components of the friction material are mixed for 10 min by using a mixer to obtain an evenly mixed friction material mixture; then, the friction material mixture is pressurized for 5 seconds under 16 Mpa at the temperature of 160° C., exhausted for 5 seconds and circulated 5 times to obtain a press-formed product; then, the press-formed product is thermally treated for 2 hours at the temperature of 190° C.; and finally, the thermally treated product is sprayed with protective paint and cured for 20 min at the temperature of 160° C.

Next, braking efficiency tests are performed in terms of second effectiveness, third effectiveness, third effectiveness, and fourth effectiveness respectively according to the bench test method of passenger car braking devices under JASO C406-2000; and the average wear extent tests are performed for the brake pad and brake disc respectively according to the bench wear test method for automobile parts-drum brake pads and disc brake pads-under JASO C427-2009. Test results are shown in Tables 5 to 6.

For the occurrence frequency of noise, when tests are performed on the bench test equipment for passenger car braking devices under JASO C406-2000, the number of occurrences of unacceptable human noise (≥55 dB) is calculated, divided by the number of occurrences of sound, and evaluated in percentage as a noise occurrence rate.

Next, a service noise test is performed as follows: service tests are performed under the following conditions of the initial speed of 30 km/h and 50 km/h, the deceleration of 0.49-1.96 m/s2, the temperature of 50-200° C., and the repetition number of 200 times, and the occurrence rate of the noises (≥55 dB) generated during all the braking is evaluated according to the following criteria.

Among them, “good” indicates the occurrence rate of noise is less than 1% (including 1%); “excellent” indicates the occurrence rate of noise is more than 1% (excluding 1%) and less than 30% (including 30%); and “poor” indicates the occurrence rate of noise is more than 30% (excluding 30%).

TABLE 5
Physical test results of the friction layers prepared from the environment-
friendly friction materials according to Examples 2-7 of the invention

| Test item | | | | Example 2 | Example 3 | Example 4 | Example 5 | Example 6 | Example 7 | Example 8 |
|---|---|---|---|---|---|---|---|---|---|---|
| Braking | Second | 50 | KM/h | 0.37 | 0.38 | 0.35 | 0.36 | 0.37 | 0.37 | 0.38 |
| efficiency | effectiveness | 100 | KM/h | 0.35 | 0.37 | 0.37 | 0.36 | 0.37 | 0.37 | 0.36 |
| | | 130 | KM/h | 0.37 | 0.37 | 0.37 | 0.38 | 0.35 | 0.38 | 0.35 |
| | Third | 100 | KM/h | 0.36 | 0.36 | 0.37 | 0.36 | 0.37 | 0.36 | 0.38 |
| | effectiveness | | | | | | | | | |
| | Fourth | 50 | KM/h | 0.36 | 0.37 | 0.37 | 0.36 | 0.38 | 0.36 | 0.37 |
| | effectiveness | 100 | KM/h | 0.35 | 0.38 | 0.38 | 0.36 | 0.36 | 0.38 | 0.37 |
| | | 130 | KM/h | 0.37 | 0.35 | 0.37 | 0.35 | 0.36 | 0.35 | 0.35 |

| | | | | | | | | | |
|---|---|---|---|---|---|---|---|---|---|
| Wear | Brake pad | AVG | 0.4 | 0.48 | 0.42 | 0.52 | 0.55 | 0.6 | 0.55 |
| extent (mm) | Brake pad | AVG | 0.001 | 0.002 | 0.001 | 0.002 | 0.003 | 0.003 | 0.001 |
| Heat fade | First time | AVG | 0.35 | 0.37 | 0.36 | 0.35 | 0.37 | 0.36 | 0.36 |
| | | MIN | 0.26 | 0.26 | 0.24 | 0.21 | 0.24 | 0.25 | 0.23 |
| | Second time | AVG | 0.35 | 0.36 | 0.36 | 0.34 | 0.36 | 0.35 | 0.35 |
| | | MIN | 0.24 | 0.23 | 0.22 | 0.24 | 0.22 | 0.25 | 0.21 |

| | | | | | | | | | |
|---|---|---|---|---|---|---|---|---|---|
| Bench brake noise (≥55 dB) | 50 | KM/h | 0.37 | 0.38 | 0.35 | 0.36 | 0.37 | 0.37 | 0.38 |
| Service brake noise (≥55 dB) | 100 | KM/h | 0.35 | 0.37 | 0.37 | 0.36 | 0.37 | 0.37 | 0.36 |

TABLE 6
Physical test results of the friction layers prepared from the friction materials
according to Comparative Examples 1-4 and Example 1 of the invention

| | | | | Comparative | Comparative | Comparative | Comparative | |
|---|---|---|---|---|---|---|---|---|
| Test item | | | | Example 1 | Example 2 | Example 3 | Example 4 | Example 1 |
| Braking | Second | 50 | KM/h | 0.38 | 0.34 | 0.35 | 0.37 | 0.36 |
| efficiency | effectiveness | 100 | KM/h | 0.36 | 0.37 | 0.37 | 0.35 | 0.37 |
| | | 130 | KM/h | 0.33 | 0.34 | 0.36 | 0.35 | 0.36 |
| | Third | 100 | KM/h | 0.34 | 0.35 | 0.36 | 0.37 | 0.36 |
| | effectiveness | | | | | | | |
| | Fourth | 50 | KM/h | 0.35 | 0.33 | 0.35 | 0.38 | 0.35 |
| | effectiveness | 100 | KM/h | 0.37 | 0.37 | 0.35 | 0.35 | 0.37 |
| | | 130 | KM/h | 0.34 | 0.34 | 0.33 | 0.36 | 0.38 |

| | | | | | | | |
|---|---|---|---|---|---|---|---|
| Wear | Brake pad | AVG | 0.46 | 0.61 | 0.53 | 0.5 | 0.48 |
| extent (mm) | Brake disc | AVG | 0.001 | 0.002 | 0.002 | 0.003 | 0.001 |
| Heat fade | First time | AVG | 0.35 | 0.34 | 0.36 | 0.36 | 0.36 |
| | | MIN | 0.22 | 0.25 | 0.26 | 0.26 | 0.25 |
| | Second time | AVG | 0.36 | 0.31 | 0.32 | 0.36 | 0.35 |
| | | MIN | 0.24 | 0.21 | 0.2 | 0.24 | 0.24 |

| | | | | | |
|---|---|---|---|---|---|
| Bench brake noise (≥ 55 dB) | 0.2 | 0.5 | 0.3 | 0.3 | 0.2 |
| Service brake noise (≥ 55 dB) | Good | Poor | Excellent | Excellent | Good |

The above illustration and description provide the basic principles and main features as well as the advantages of the invention. Those skilled in the art should understand that the invention is not limited by the embodiments described above. The embodiments described above and the description in the specification are merely for the purpose of explaining the principle of the invention. There may be a variety of variations and improvements made to the invention without departing from the inventive spirit and scope of the invention. These variations and improvements shall be construed as falling within the scope claimed by the invention. The scope claimed by the invention should be defined by the appended claims and equivalents thereof.

What is claimed is:

1. An environment-friendly friction material, consisting of the following components in parts by weight: 8-15 parts of a binding material, 3-8 parts of an organic fiber, 3-8 parts of an inorganic fiber, 3-8 parts of an anti-friction material, 15-25 parts of granite powder, 35-40 parts of marble powder, 6-10 parts of a modified organic filling material, 5-10 parts of an acidity or alkalinity regulating material, and 0.5-4.5 parts of a non-copper metal material.

2. The environment-friendly friction material according to claim 1, wherein the binding material is one or a combination of some of phenolic resin, boron modified phenolic resin, cashew nut shell liquid modified phenolic resin and natural rubber.

3. The environment-friendly friction material according to claim 1, wherein the organic fiber is one or a combination of some of an aramid fiber and a polyacrylic fiber.

4. The environment-friendly friction material according to claim 1, wherein the inorganic fiber is one or a combination of some of a potassium titanate fiber, a glass fiber, a ceramic fiber, and a basalt fiber.

5. The environment-friendly friction material according to claim 1, wherein the anti-friction material is one or a combination of some of graphite, tin sulfide, and molybdenum disulfide.

6. The environment-friendly friction material according to claim 1, wherein the acidity or alkalinity regulating material is one or a combination of some of calcium hydroxide, gypsum powder, lime, and slaked lime.

7. The environment-friendly friction material according to claim 1, wherein the non-copper metal material is one or a combination of some of titanium, iron, nickel, zinc, and heat-resistant duralumin.

8. The environment-friendly friction material according to claim 1, wherein the modified organic filling material consists of the following components in parts by weight: 20-50 parts of tyre powder, 15-25 parts of a shoe sole waste, 10-15 parts of a sepiolite fiber, 2-3 parts of a silane coupling agent, 2-5 parts of a cashew nut shell liquid, and 0.5-2 parts of an activator, with the shoe sole waste comprising 15-30% of POE and 5-15% of EPDM.

9. The environment-friendly friction material according to claim 8, wherein a process for preparing the modified organic filling material comprises the following steps:
S1, modification of the sepiolite fiber: adding 10-15 parts of the dried sepiolite fiber and deionized water at a solid-to-liquid ratio of 1:5 to a dispersant, dispersing at 1500 r/min-1800 r/min for 5 min, then adding 2-3 parts of the silane coupling agent, dispersing at an increased revolving speed of 2500 r/min for 60 min to obtain a slurry, which is then dried in a constant-temperature drying oven at 110° C., and then finely grinding the dried modified sepiolite fiber by a ball mill for later use;
S2, activation of the tyre powder: mixing the 20-50 parts of tyre powder, the 2-5 parts of a cashew nut shell liquid, and the 0.5-2 parts of an activator in a high-speed mixer at a revolving speed of 70 r/min-100 r/min for 5 min-10 min to obtain premixed powder, which is then activated and modified in a torque rheometer with a revolving speed of 70 r/min-100 r/min and a temperature of 120° C-160° C. for 5 min-30 min to obtain modified tyre powder, and finally, cooling the modified tyre powder under natural conditions to normal temperature for later use;
S3, preprocessing of the shoe sole waste: stripping to remove miscellaneous substances and keep EVA insoles, physically shredding the EVA insoles in a shredding machine, and washing and drying the shredded EVA insoles to obtain the shoe sole waste for later use; and
S4, mixing the modified sepiolite fiber from Step S1, the modified tyre powder from Step S2 and the shoe sole waste from Step S3 fully and evenly, feeding to a double-screw extruder for melting, extruding and granulating.

10. An environment-friendly friction material product, comprising a friction layer prepared from the environment-friendly friction material according to claim 1.

11. An environment-friendly friction material product, comprising a friction layer prepared from the environment-friendly friction material according to claim 2.

12. An environment-friendly friction material product, comprising a friction layer prepared from the environment-friendly friction material according to claim 3.

13. An environment-friendly friction material product, comprising a friction layer prepared from the environment-friendly friction material according to claim 4.

14. An environment-friendly friction material product, comprising a friction layer prepared from the environment-friendly friction material according to claim 5.

15. An environment-friendly friction material product, comprising a friction layer prepared from the environment-friendly friction material according to claim 6.

16. An environment-friendly friction material product, comprising a friction layer prepared from the environment-friendly friction material according to claim 7.

17. An environment-friendly friction material product, comprising a friction layer prepared from the environment-friendly friction material according to claim 8

18. An environment-friendly friction material product, comprising a friction layer prepared from the environment-friendly friction material according to claim 9.
